(19) United States
(12) Patent Application Publication
(10) Pub. No.: US 2008/0197246 A1
(43) Pub. Date: Aug. 21, 2008

(54) Adapter for article display stand

(75) Inventor: Dennis D. Belden, Canton, OH (US)

Correspondence Address: SAND & SEBOLT, AEGIS TOWER, SUITE 1100, 4940 MUNSON STREET, NW, CANTON, OH, 44718-3615, US

(73) Assignee: Alpha Security Products, Inc., Charlotte, NC (US)

(21) Appl. No.: 11/708,854

(22) Filed: Feb. 20, 2007

(51) Int. Cl. F16M 11/00; A47G 1/17

(52) U.S. Cl. 248/176.1; 248/205.3

(57) ABSTRACT

An adapter includes a rigid plate which has a plurality of fastener elements extending from one side. The fastener elements align with fastener-receiving holes formed in a member heretofore intended to receive fasteners for mounting the member on a supporting surface. An exposed side of the plate has pressure sensitive adhesive for securing the member to a support surface eliminating the use of fasteners extending directly from the member into the support surface. Preferably, the plate fastener elements are self-clinching and are press-fitted in the plate and have threaded bores for receiving fasteners which extend through the usual mounting holes formed in the base of the member to secure the plate to the member eliminating the use of screws for attaching the member to a support surface.

### BACKGROUND OF THE INVENTION

1. Technical Field

The invention relates to stands for displaying items of merchandise as in a retail environment. Even more particularly, the invention relates to an adapter for use with a display stand enabling the display stand to be attached to a surface such as glass, stone, concrete or other such surfaces with a pressure sensitive adhesive where usual fastening screws cannot be used due to the nature of the surface or to prevent permanent marring of the support surface.

2. Background Information

Retail stores have a difficult time protecting items of merchandise which the potential customer wishes to visually inspect and handle prior to making the decision to purchase the item. Often such items have been kept in glass cases under lock and key which does not allow a customer to handle the item without assistance of store personnel. In addition, while such items may be secured to a foundation or base by a cable or the like, this does not prevent the theft of the item by cutting of the cable or detaching the product from the cable.

Therefore, various security devices have been developed which includes a display stand which is secured to a support surface, such as a merchandise display shelf, which supports a sensor that is attached to an item of merchandise, and which is mechanically and electrically connected by a lanyard to the display stand. This enables the potential customer to pick up and handle the item such as cell phones, cameras etc. These display stands and sensors have proven satisfactory for many retail applications. Some examples of such display stands are shown in pending patent application Ser. No. 11/454,513, filed Jun. 16, 2006; Ser. No. 11/431,291, filed May 10, 2006; and Ser. No. 60/880,132, filed Jan. 12, 2007.

These display stands are intended to be securely attached to a support surface usually by a plurality of screws which extend through openings formed in the base of the stand, with the heads of the attachment screws being concealed within the bottom base of the support stand. Although this is satisfactory for many applications, it is desirable at certain locations to support the display stand on a surface which is not suitable for receiving fastening screws such as glass countertops, stone or concrete supports, or even support shelves of wood or steel where it is not desirable to mar the surface by the formation of fastening holes into and through the support structure. However, it is desirable to be able to use the article display stand for both applications, that is, it can be securely fixed to a support surface without the use of screws or attached by other means to a different type of support surface without alteration of the display stand and without increased cost and reconfiguring the display stand.

Therefore, the need exists for a relatively simple and inexpensive device which enables a usual display stand heretofore attached by threaded fasteners to the support surface to be easily and securely mounted on other types of support surfaces without the use of fasteners inserted into the supporting structure.

### BRIEF SUMMARY OF THE INVENTION

One aspect of the present invention is to provide a display stand for displaying articles of merchandise which has a base formed with a plurality of holes through which threaded fasteners are inserted and screwed into a support structure for securely mounting the stand on the support structure, wherein an adapter is mounted on the bottom of the display stand without modifying the display stand, yet enabling this display stand to be securely mounted to a support surface such as glass, stone, wood etc. without marring the supporting surface.

A further feature of the present invention is to provide such an adapter which can be inexpensively and mass produced, which is attachable to the bottom of a usual article display stand and permanently secured thereto, and subsequently attached by a pressure sensitive adhesive on a support surface without marring the support surface.

A further aspect of the present invention is to provide the adapter with a rigid plate formed with a plurality of holes in which self-clinching fasteners can be press-fitted so that the heads thereof are generally flush with the outer surface of the plate over which a layer of double sided pressure sensitive adhesive is applied, with the fasteners having a portion which projects beyond the opposite surface of the adapter plate providing a threaded bore which is adapted to receive fasteners extending from the usual mounting holes of the display stand into the threaded bore for securing the plate to the bottom of the display stand.

Another feature of the present invention is to provide the adapter with a switch cap which is connectable to a plunger switch extending from the bottom of the display stand, wherein the switch cap extends through a complementary-shaped hole formed in the plate and engages the support surface when the stand is secured thereto, thereby enabling a plunger switch within the display stand to still be operable to sound an alarm if the display stand is removed from the support structure. Alternately, a switch with a longer plunger of the appropriate length can be used and not require such a switch cap.

A further feature of the present invention is to provide the adapter plate with a pair of switch cap holes so that regardless of the direction that the plate is attached to the bottom of the display stand, the plunger switch is engageable with the switch cap enabling the display stand to be correctly oriented on the support surface.

A further aspect of the present invention is to form a double sided piece of pressure sensitive adhesive with a ring-like configuration which reduces the amount of material, as well as the need for forming switch cap holes therethrough, yet which provides sufficient adhesive for securing the plate to a support surface. Furthermore, this ring shape enables the adapter to be more easily removed without damaging the support surface when an extremely strong adhesive is used for the pressure sensitive adhesive.

Still another feature of the present invention is to form the adapter plate with a configuration to closely match the configuration of the base of the display stand to render it less obtrusive to the display area, and in which the adapter plate can be formed of a rigid metal or plastic material and of a color to match that of the display stand.

Another feature of the present invention is to provide the adapter in a kit form consisting of the plate with the self-clinching fasteners press-fitted therein, a piece of double sided adhesive protected by layers of an adhesive release paper, and a plurality of fasteners for attaching the plate to the bottom of the display stand together with the switch cap which is easily inserted over the plunger of a plunger switch located within the base of the display stand.

These features and objectives are obtained by the adapter of the present invention used for mounting a member to a support surface, the general nature of which may be stated as comprising a rigid plate having opposed first and second surfaces; a plurality of first fasteners extending through the plate; a plurality of second fasteners adapted to extend from the member for engaging the first fastener for securing the plate to the member; and an adhesive on the first surface for securing the plate to the support surface.

These objectives and advantages are further obtained by the method of the present invention for securing a member to a support structure comprising the steps of providing a plate having a plurality of fastener elements extending from a first surface of the plate, wherein said fastener elements have threaded bores; attaching a piece of material having pressure sensitive adhesive on at least one side on a second surface of the plate; securing the plate to the member by threaded fasteners extending through mounting holes formed in the member and into the threaded bores of the fastener elements; and pressing the pressure sensitive adhesive against the support structure to secure the member to the support structure.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a side elevational view with portions in section of a prior art article display stand mounted on a support surface.

FIG. 2 is an exploded perspective view of the adapter for mounting on an article display stand such as shown in FIG. 1.

FIG. 3 is a fragmentary elevational view of the adapter mounting an article display stand on a support surface.

FIG. 4 is an enlarged fragmentary sectional view of the encircled portion of FIG. 3.

FIG. 5 is an enlarged fragmentary sectional view of the encircled portion of FIG. 3.

FIG. 6 is a perspective view of a modified form of the double sided pressure sensitive adhesive.

Similar numbers refer to similar parts throughout the drawings.

### DETAILED DESCRIPTION OF THE INVENTION

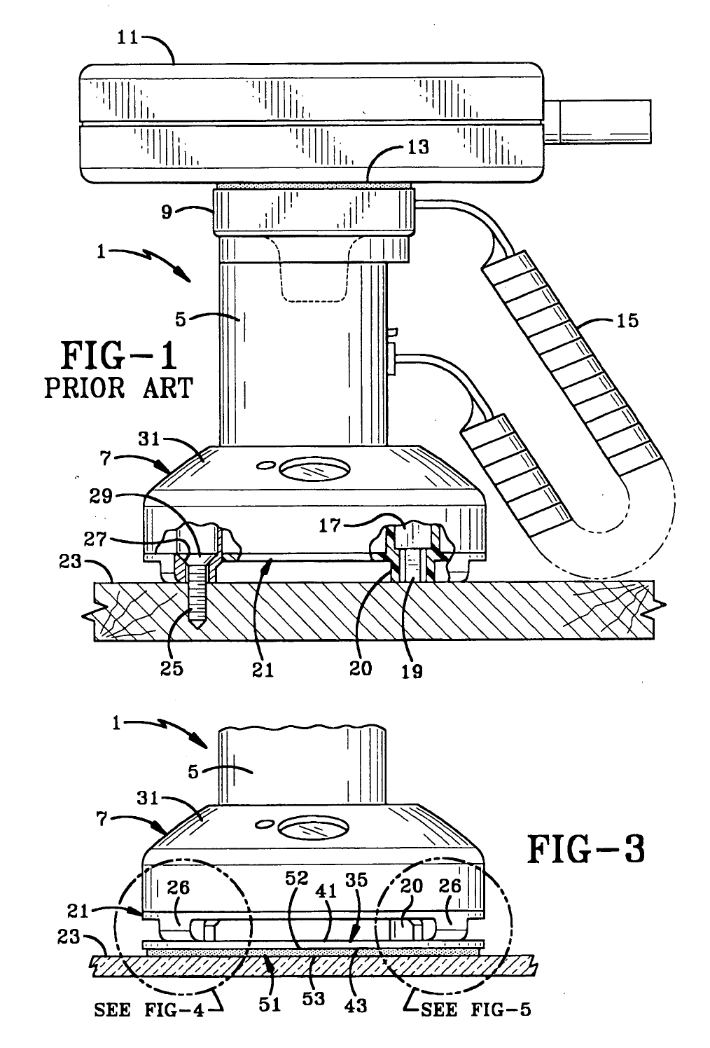

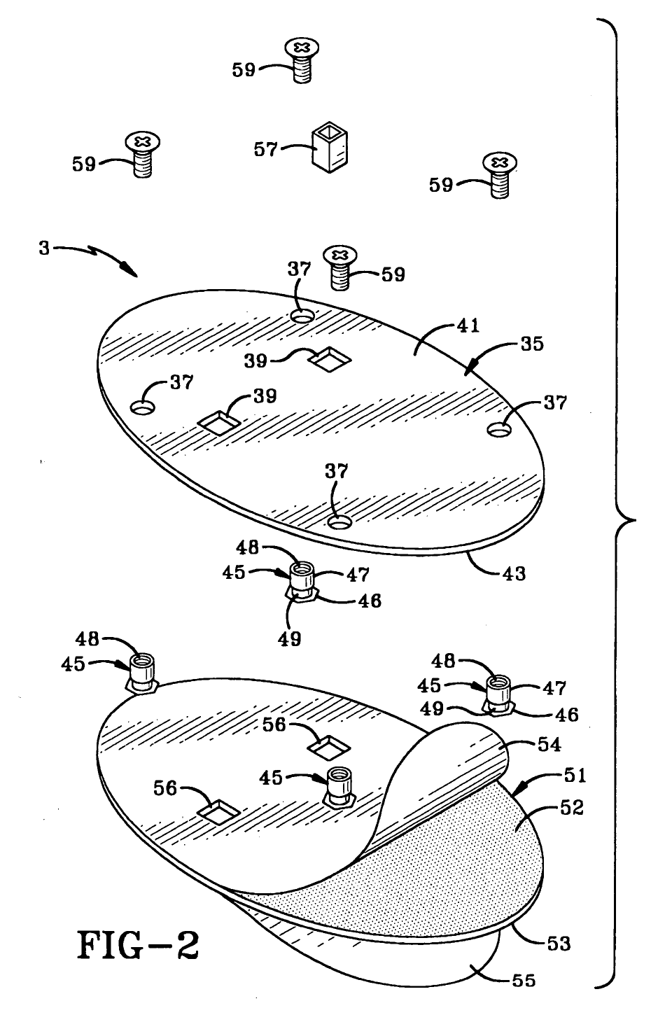

FIG. 1 is a side elevational view of an article display stand indicated generally at 1, of a type with which the adapter of the present invention which is indicated generally at 3, and shown in an exploded condition in FIG. 2 is intended for use. Display stand 1 is of the type shown in pending patent application Ser. No. 11/454,513, filed Jun. 16, 2006; Ser. No. 11/431,291, filed May 10, 2006; and Ser. No. 60/880,132, filed Jan. 12, 2007, the contents of which are incorporated herein by reference. However, this is just one illustration of a type of article display stand with which adapter 3 is intended for use and the display stand can vary from that shown in the drawings and described below and described in the three pending patent applications listed above.

Display stand 1 includes a pedestal 5 extending upwardly from a base 7 and includes a sensor 9 removably mounted on the upper end thereof which is attached to an item of merchandise 11, such as a cell phone, by a strip of pressure sensitive adhesive 13. An alarm system (not shown) is mounted within base 7 and is electrically and mechanically connected to sensor 9 by a coiled cord 15. The alarm system will include a plunger switch 17 mounted in base 7 which includes a plunger 19 extending outwardly beyond the bottom wall 21 of base 7 in a plunger housing 20 for engagement with support surface 23 when secured thereon. Display stand 1 is secured to support surface 23 by a plurality of screws 25 which extend through openings 27 formed in base 7 and aligned support posts 26. The heads 29 of screws 25 are inaccessible when the cap 31 of base 7 is snap fitted or secured on the bottom wall or base plate 21 of base 7. Again, the base structure and exact means of mounting the display stand to support surface 23 can vary without affecting the concept of the invention. The main feature is that the support stand will include a plurality of holes or openings 27 through which fasteners extend to secure the display stand to surface 23 when such fasteners are used.

The adapter of the present invention is shown in FIG. 2 and includes a main flat planar preferably thin rigid plate 35 preferably formed of metal having a thickness, for example, of 2.5 mm and having a shape which preferably matches the general shape of display stand bottom wall 21, which for the particular embodiment shown in the drawings and described is oval-shaped. However, this can vary to match that of the particular display stand with which it is intended for use in order to be less obtrusive when mounted thereon. Plate 35 is formed with a plurality of holes 37, four of which are shown in the preferred embodiment, which align with the number and location of openings 27 formed in bottom wall 21 of display stand 1. One or two openings 39 are also formed in plate 35, one of which will be aligned with plunger 19 when plate 35 is mounted on display stand 1 as discussed further below. Plate 35 has a pair of opposed surfaces 41 and 43 which are generally parallel with each other and have a flat planar configuration.

A plurality of first fastening elements 45 are mounted in hole 37 with the preferred type of fastening element being a self-clinching fastener, and preferably a self-clinching standoff fastener which includes a thin flat base 46, a tubular boss 47 formed with an internal threaded bore 48, separated by base 46 by an annular groove 49. Fasteners 45 are press-fitted into holes 37 which causes the displaced metal to flow into grooves 49 between tubular boss 47 and base 46 to firmly secure fastener components 45 in holes 37 with base 47 being relatively flush with plate surface 43 when installed therein as shown in FIG. 4. One such type of fastener is sold under the trademark PEM®.

If desired, holes 37 can be pierced into the metal and then tapped to form the internal threads or drilled into the metal and then tapped to form the threads within the concept of the present invention and would only require selecting the correct length of the threaded fasteners to be received therein.

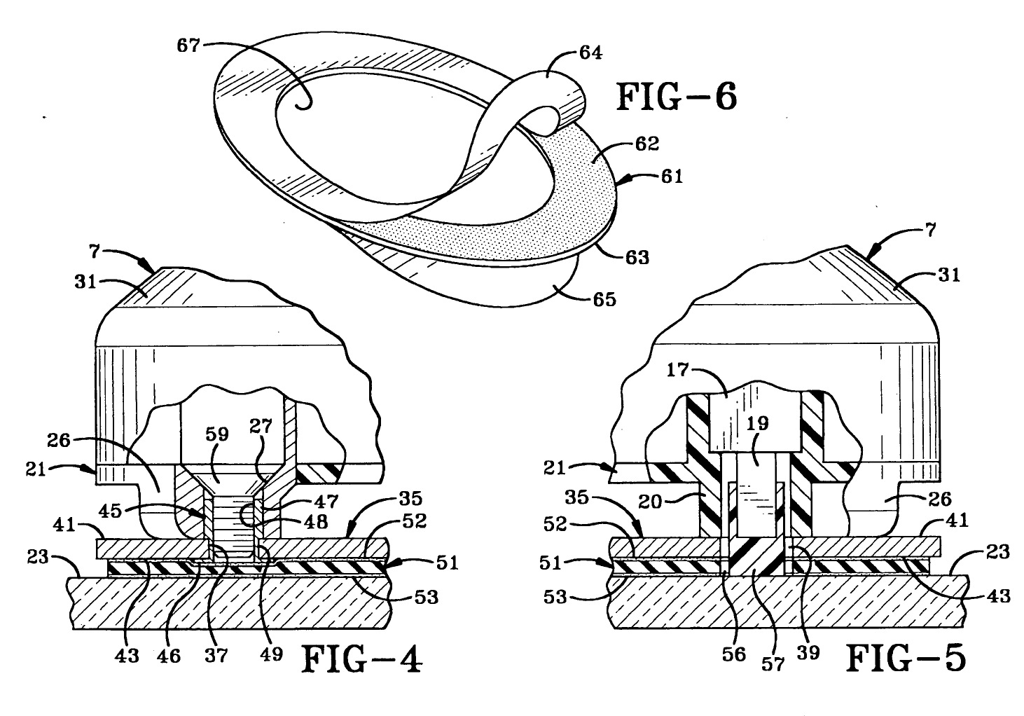

A double sided strip of material indicated generally at 51, has a coating of pressure sensitive adhesive 52 and 53 on opposite sides and is ultimately attached to adapter plate 35. When adapter 3 is shipped to a customer in kit form, both sides of pressure sensitive adhesive 52 and 53 are protected by an adhesive release paper 54 and 55, respectively, to protect the adhesive until needed. The adapter kit may also contain a switch cap 57 which may have a rectangular shape as shown in FIG. 7, which regardless of its shape, preferably is complementary to the shape of openings 39. Switch cap 57 is placed on plunger 19 (FIG. 5) to provide an extension thereto so that when display stand 1 is attached to adapter 3, it will extend through one of the holes 39 in plate 35 and through an aligned hole 56 formed in strip 51 and contact support surface 23 to be depressed when display stand 1 is secured thereto, activating the switch and its connection to the internal alarm within base 7. The adapter kit will also include a plurality of screws 59 or similar type of fastener which is complementary to the internal threaded bore 48 of fastening elements 45. When supplied in kit form, fastening elements 45 will be press-fitted into plate 35 ready to receive fasteners 59 therein.

The operation and method of use of adapter 3 is easily shown in FIGS. 3, 4 and 5. Plate 35, after having fastening elements 45 installed therein and after removal of adhesive release paper 54 is attached to bottom surface 43 of plate 45 as shown in FIG. 4 which will cover the fastener bases 46 and secure the double sided pressure sensitive adhesive strip 51 to plate 35. Screws 59 are then inserted through openings 27 of display stand bottom wall 21 and support posts 26 which heretofore were used for receiving screws 25 (FIG. 1) and are threadably engaged within threaded bores 48 to securely fix plate 35 onto the bottom of display stand 1. When securing plate 35 to the bottom of display stand 1, switch cap 57 which will have been previously placed on plunger 19 and is inserted through one of the openings 39 of plate 35 and one of the openings 56 in adhesive strip 51. The use of two holes 35 will always ensure that no matter which way plate 35 is attached to the base by fasteners 39, one of the holes 39 will align with the plunger switch. However, only one hole is required, but two holes merely provide more convenience and a fool-proof mounting of the plate on the display stand.

After securing plate 35 to the bottom of display stand 1 by fasteners 59, adhesive release paper 55 is removed from adhesive layer 53 and the stand is placed at the desired location and pressed downwardly to secure adhesive layer 53 into a firm sealing engagement with support surface 23 securing display stand 1 thereon and actuating plunger switch 17. It is readily understood that should display stand 1 not be required at the particular installed location, the pressure sensitive adhesive can be pried loose from the support surface and any remnants easily removed by various cleaning compounds placing the support surface 23 into its original condition without any permanent damage or marking thereof which results when heretofore screws 25 are used. This enables support stand 1 to be attached to various surfaces such as glass, marble, stone, concrete, etc. in which screws 25 cannot be used or are not desired due to their permanent marking of the support surface. Adapter 1 also enables the plunger switch to be utilized providing the desired security to display stand 1.

FIG. 6 discloses another embodiment of the strip of pressure sensitive adhesive indicated at 61, having pressure sensitive adhesive 62 and 63 on both sides thereof, which is protected by release paper 64 and 65, respectively. The double sided pressure sensitive adhesive strip 61 is in a ring-shaped configuration with a central opening 67 which is attached to plate surface 43 as discussed above with respect to strip 51. Strip 61 provides a slightly less adhesive securement than that of the full pad of pressure sensitive adhesive, but can be less expensive due to material costs. Its application to plate 35 is the same as that discussed above with respect to the double sided pressure sensitive adhesive strip or pad 51. It is also readily understood that the piece of double sided pressure sensitive adhesive could have various configurations whether a solid oval shape configuration as shown by strip 51 or a ring-shaped configuration as shown by strip 61 and could be rectangular, circular etc. without affecting the concept of the invention. Preferably it will be configured to match the particular shape of plate 35.

Thus, the adapter of the present invention provides a relatively simple, inexpensive and convenient means of attaching an article display stand or other type of object to a support surface without the use of permanent marking fasteners by utilizing the existing mounting holes in the display stand or attached member avoiding any modification to the member being attached to a support surface. Furthermore, it can be subsequently removed and relocated to another position if desired without leaving any permanent marks on the support surface on which the pressure sensitive adhesive was applied. It also enables the security switches used with certain types of display stands to be utilized if contained in the display stand. Although it is described for an article display stand which provides security to the object displayed thereon, it is readily understood that it can be used to attach other types of members which heretofore are attached to surfaces by permanents fasteners.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An adapter for mounting a member to a support surface comprising:
a rigid plate having opposed first and second surfaces;
a plurality of first fastening elements formed in the plate;
a plurality of second fastening elements adapted to extend from the member for engaging the first fastening elements for securing the plate to the member; and
an adhesive on the first surface for securing the plate to the support surface.

2. The adapter defined in claim 1 wherein the first fastening elements are self-clinching standoff fasteners having a threaded bore for receiving the second fastening elements.

3. The adapter defined in claim 2 wherein the plate is formed with a plurality of holes; and in which the self-clinching standoff fasteners are press-fitted into said holes whereby the heads of said standoff fasteners are generally flush with the first surface of the plate.

4. The adapter defined in claim 1 wherein a double sided piece of pressure sensitive adhesive is secured to the first surface of the plate and provides the adhesive for securing the plate to the support surface.

5. The adapter defined in claim 4 wherein the double sided piece of pressure sensitive adhesive has a generally ring-shaped configuration.

6. The adapter defined in claim 4 wherein one side of the double sided piece of pressure sensitive adhesive is covered by an adhesive release paper.

7. The adapter defined in claim 1 including a switch cap adapted to be connected to a plunger switch extending from the member; and in which the plate is formed with an opening for receiving the switch cap therein.

8. The adapter defined in claim 7 wherein two openings are formed in the plate for selectively receiving the switch cap in one of said two openings to enable proper orientation of the member on the support surface.

9. In combination, a member having a support surface for mounting the member on a support structure with fasteners cooperating with a plurality of holes formed in the member; and an adapter secured to the member for securing the member on the support surface with an adhesive, said adapter comprising a plate having opposed first and second surfaces, an adhesive on the first surface of the plate for securing the adapter on the support structure; and a plurality of first fastening elements in the plate and aligned with the holes in the member for securing the plate to said member.

10. The combination defined in claim 9 wherein a piece of double sided pressure sensitive adhesive has one side secured to the first side of the plate, with the second side of the adhesive piece adapted to secure the plate to the support surface.

11. The combination defined in claim 9 wherein the member has a switch projecting below the support surface; and in which a switch cap is mounted on the switch and extends through an opening formed in the plate.

12. The combination defined in claim 9 wherein the first fastening elements are self-clinching standoff fasteners having a threaded bore; and in which a plurality of second fasteners extend through the holes formed in the member and into the threaded bores of the standoff fasteners for securing the member to the plate.

13. The combination defined in claim 9 wherein the member is a pedestal supporting a sensor adapted to be secured to an item of merchandise; and wherein the pedestal contains an alarm switch which is actuated upon unauthorized removal of the member from the support surface.

14. A method of securing a member to a support structure including the steps of providing a plate having a plurality of fastening elements extending from a first surface of the plate, wherein said fastening elements have threaded bores; applying a pressure sensitive adhesive on a second surface of the plate; securing the plate to the member by threaded fasteners extending through mounting holes formed in the member and into the threaded bores of the fastening elements; and pressing the sensitive adhesive of the plate against the support structure to secure the member to said support structure.

15. The method defined in claim 14 including the step of forming the plate with a plurality of holes and press-fitting a plurality of self-clinching standoffs in said holes to provide the fastening elements.

16. The method defined in claim 14 including the step of attaching a switch cap to a plunger switch extending from the member; and inserting the plunger cap through a hole formed in the plate.

17. The method defined in claim 14 including the step of providing a piece of material with pressure sensitive adhesive on both sides, and attaching the piece of material on the second surface of the plate by the pressure sensitive adhesive on one side of the piece of material.

18. A kit for mounting on an object heretofore attached to a support surface by fasteners extending through mounting holes in the object and into the support surface, said kit comprising:
a plate having first and second sides;
a plurality of first fastening elements in the plate;
a plurality of second fastening elements adapted to extend through the mounting holes in the object and into engagement with the first fastening elements for attaching the plate on the object; and
an adhesive on the first surface for securing the object on a support surface.

19. The kit defined in claim 18 wherein the first fastening elements are self-clinching standoff fasteners press-fitted into holes formed in the plate; and wherein said standoff fasteners have threaded bores for receiving the second fasteners therein.

20. The kit defined in claim 18 including a piece of double sided pressure sensitive adhesive, each side protected by an adhesive release paper.
